(19) United States
(12) Patent Application Publication
(10) Pub. No.: US 2020/0159304 A1
(43) Pub. Date: May 21, 2020

(54) INTERACTIVE UNINTERRUPTABLE POWER SUPPLY FOR HIGH CURRENT PROCESSOR TRANSIENTS

(71) Applicant: HEWLETT PACKARD ENTERPRISE DEVELOPMENT LP, Houston, TX (US)

(72) Inventors: Daniel Humphrey, Tomball, TX (US); Mohamed Amin Bemat, Cypress, TX (US)

(21) Appl. No.: 16/195,974

(22) Filed: Nov. 20, 2018

(51) Int. Cl. G06F 1/324; G06F 1/30; G06F 1/3206

(52) U.S. Cl. CPC G06F 1/324; G06F 1/3206; G06F 1/30

(57) ABSTRACT

A supplemental power supply system of a computing device may determine an occurrence of a transient at a processor of the computing device having a first electrical power supplied by a primary power supply of the computing device different from the supplemental power supply system. A discharging circuitry of the supplemental power supply system may, in response to determining the occurrence of the transient: discharge electrical energy from energy storage of the supplemental power supply system and supply a second electrical power to the processor using the electrical energy discharged from the energy storage.

### TECHNICAL FIELD

The present disclosure generally relates to a power supply system and more specifically relates to a supplemental power supply system that supplies supplemental electrical power to a processor in response to transients occurring at the processor.

### BACKGROUND

During operation, a processor of a computing device may experience transients, which may be a rapid increase in current that is drawn by the processor at a level that is significantly above the level of current drawn by the processor during regular operations. Such transients may occur when the processor, while operating at a particular clock rate (i.e., frequency), instantly increases the clock rate at which it operates (also known as “overclocking” the processor).

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example computing device that includes a supplemental power supply system for supplying electrical power to a processor in response to a transient that occurs at the processor.

FIG. 2 illustrates an example process for supplementing the electrical power supplied by an example power supply when a transient occurs at an example processor, using the example computing device of FIG. 1.

FIG. 3 illustrates an example process for supplementing the electrical power supplied by an example power supply when a transient occurs at an example processor, using the example computing device of FIG. 1.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed system provides for a supplemental power supply system in a computing device that may supply electrical power to components of the computing device when a transient occurs at a processor of the computing device. The supplemental power supply system may be a separate system from a primary power supply that supplies electrical power to the components of the computing device and may supplement the primary power supply by supplying additional electrical power when a transient occurs at the processor.

A computing device may include a primary power supply that is designed to supply the average amount of electrical power required by components of the computing device. However, the computing device may include processors that may periodically increase its operating frequency for a sustained period of time to increase its performance. Such an increase in the operating frequency of a processor may be referred to as a transient occurring at the processor, and the transient persisting for a sustained period of time (e.g., several milliseconds) may cause the processor to draw an increased amount of electrical power that cannot be supplied by the primary power supply that is designed to supply an average amount of electrical power required by the computing device. Further, even if a primary power supply of the computing device is capable of supplying the increased amount of electrical power that the processor requires during the transient, the primary power supply may not be able to increase the amount of electrical power that it supplies to the processor fast enough to maintain voltage requirements.

To solve the technical problem described above of how to increase the supply of electrical power to a processor that is available when a transient occurs at the processor, aspects of the disclosure describes a technical solution that includes a supplemental power supply system. The supplemental power supply system may determine whether a transient is occurring at a processor and may supply electrical power to the processor when the supplemental power supply system determines that a transient is occurring at the processor to compensate for the power supply being unable to increase its supply of electrical power to the processor to the increased level of electrical power required by the processor when transients occur. The supplemental power supply system thereby improves the functionality of the computing device itself by supplying the electrical power required by processors of the computing device when transients occur at the processors.

The supplemental power supply system may also potentially provide technical advantages over alternative techniques for increasing the supply of electrical power to a processor when a transient occurs at the processor. One alternative technique includes the use of an oversized primary power supply that is able to supply an increased amount of electrical power when the processor requests an increased amount of electrical power when transients occur. However, such a power supply may be much larger in size and much more expensive than the combination of a normal power supply that is able to supply an average level of electrical power to the computing device with the supplemental power supply system described herein. Furthermore, such a power supply may still not be able to supply the increased amount of electrical power to the processor in a timely manner when transients occur at the processor.

Further, the supplemental power supply system may be more easily upgraded with additional energy storage capacity to handle future processors that may further increase the amount of electrical power required when transients occur. In contrast, upgrading and/or redesigning power supplies to be able to handle future increases in the amount of electrical power required when transients occur may be relatively more expensive and may require large fixed costs. In these and many other ways the techniques described herein provide a technical solution to a technical problem and improves the computing device itself.

### Example System Architecture

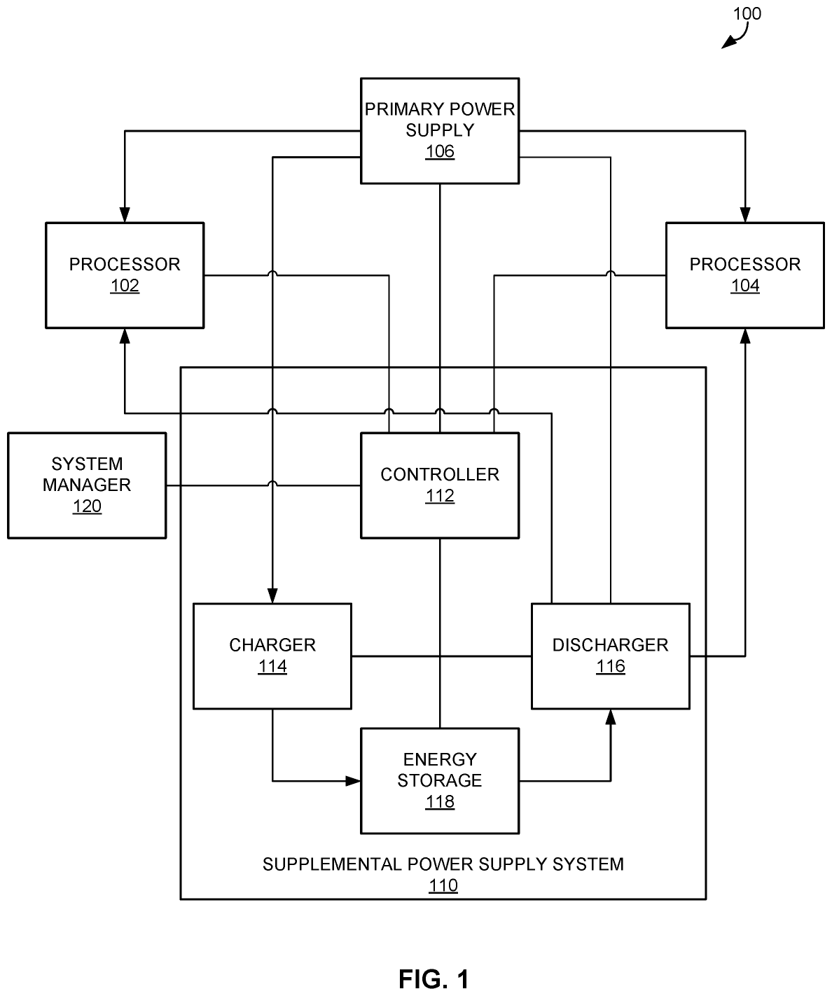

FIG. 1 illustrates an example computing device that includes a supplemental power supply system for supplying electrical power to a processor in response to a transient that occurs at the processor. As shown in FIG. 1, computing device 100 may include processor 102, processor 104, primary power supply 106, supplemental power supply system 110, and system manager 120. Primary power supply 106 is operably coupled to processors 102 and 104, and is operable to supply power to processors 102 and 104. Supplemental power supply system 110 is operably coupled to processor 102, processor 104, and primary power supply 106, and is operable to supply power to processors 102 and 104 to supplement the power supplied by primary power supply 106 when excess current transients occur at processor 102 and/or processor 104. System manager 120 is operably coupled to supplemental power supply system 110 and is operable to communicate with supplemental power supply system 110 to provide information that supplemental power supply system 100 may use to control its operations.

Computing device 100 may include server computers, desktop computers, mobile computers, tablet computers (e.g., including e-book readers), mobile devices (e.g., a smartphone or PDA), set top boxes (e.g., for a television), video game consoles, or any other devices having appropriate processor(s), memory, and communications capabilities. Processors 102 and 104 may be operable to execute instructions, such as instructions physically coded into processors 102 104, instructions received from software in memory (not shown) of computing device 100, or a combination of both. Processors 102 and 104 may include central processing units (CPUs), graphics processing units (GPUs), and the like. GPUs may include general purpose graphics processing units (GPGPUs), stream processors, and the like. In the example of FIG. 1, processor 102 may be a CPU while processor 104 may be a GPU that operates as a GPGPU.

Primary power supply 106 may also be referred to as a power supply unit and may be operable to supply power to the internal components of computing device 100, including processors 102 and 104 and supplemental power supply system 110. In some examples, primary power supply 106 may be operable to convert alternating-current (AC) electric power supply, such as grid power from a wall socket, to direct-current (DC) power for the internal components of computing device 100. Primary power supply 106 may be operably coupled to processors 102 and 104 and, during operation of computing device 100, primary power supply 106 may supply electrical power to processors 102 and 104 as processors 102 and 104 operate to execute instructions.

As processors 102 and 104 operate to execute instructions, primary power supply 106 may operate to supply electrical power to processors 102 and 104 as well as to other components (not shown) of computing device 100. By supplying electrical power to processors 102 and 104, primary power supply 106 may supply a level of voltage to processors 102 and 104. In some examples, computing device 100 may include voltage regulators to convert the voltage supplied by primary power supply 106 and/or supplemental power supply system 108, such as 5 volts or 12 of voltage, to a lower voltage level required by processors 102 and 104, such as 1.5 volts of voltage.

As processors 102 and 104 operate, one or both of processors 102 and 104 may experience the occurrence of a transient. A transient, as used throughout this disclosure, is a rapid increase in current that is drawn by the processor at a level that is significantly above the level of current drawn by the processor during normal operations. For example, the processor may draw over twice the amount of current during the occurrence of a transient compared to the amount of current it draws during normal operation. For example, a processor may consume 115 amps of current during normal operation, but may consume 250 amps of current during the occurrence of a transient. Such transients may occur when the processor, while operating at a particular clock rate, such as a base operating frequency, increases the clock rate at which it operates (also known as “overclocking” the processor) above the base operating frequency, and may periodically reoccur as the processor periodically increases its operating clock frequency. A processor may increase the clock rate at which it operates for a period of time in order to process heavy workloads, or may periodically increase the clock rate for a set period of time. The transient condition may continue until the processor decreases the clock rate at which it operates back to the base operating frequency. Although the term “transient” may have a connotation in some circumstances implying a brief duration, as used herein the term “transient” implies nothing about the duration of the increased power draw—the duration may be brief or lengthy or anything in between.

When a transient occurs at a processor, the processor may increase the amount of current that it draws, thereby requiring primary power supply 106 to increase the amount of electrical power supplied to the processor. The increase in current drawn by the processor may cause the level of voltage of the electrical power supplied by primary power supply 106 to drop (i.e., a voltage drop) because primary power supply 106 may not be able to instantaneously increase the amount of electrical power supplied to the processor when a transient occurs. Not only may the level of voltage of the electrical power supplied by primary power supply 106 to the processor drop as a result of the transient, but the level of voltage of electrical power supplied by primary power supply 106 to other components of computing device 100 may also drop as a result of the transient. For example, if a transient occurs at processor 102, not only may the level of voltage of the electrical power supplied by primary power supply 106 to processor 102 drop, but the level of voltage of the electrical power supplied by primary power supply 106 to processor 104 may also drop. If the level of voltage of the electrical power supplied to processors 102 and 104 drops below a level that is required by processors 102 and 104 as a result of a transient occurring at processor 102 or processor 104, processors 102 and 104 may malfunction.

In accordance with aspects of the present disclosure, supplemental power supply system 110 may be operable to supply electrical power to processors 102 and/or 104 in response to a transient occurring at processors 102 and/or 104 to provide processors 102 and/or 104 with a sufficient amount of electrical power and level of voltage for the increased current draw. The primary power supply 106 also continues to supply power to the processors 102 and/or 104 during the transient, with the power supplied by the supplemental power supply system 110 being added to the power supplied by the primary power supply 106. Thus, the power supplied by the supplemental power supply system 110 may be referred to as supplemental power. The supplemental power supply system 110 may supply the supplemental power until it is not needed anymore to satisfy the increased power draw, i.e. until the transient condition ends or until primary power supply 106 is able to increase the amount of electrical power that it supplies to a level required by processors 102 and/or 104 during the transient. By supplying the electrical power to processors 102 and/or 104, supplemental power supply system 110 compensates for the increased current draw of the transient and thus ensures that the voltage provided to processors 102 and/or 104 stays within acceptable bounds, thereby potentially avoiding a drop in the level of voltage of the electrical power supplied to processors 102 and/or 104 that would otherwise be caused by the transient.

Supplemental power supply system 110 may be operable to determine when a transient is or will be occurring at processor 102 or processor 104 and to, in response to determining that a transient is occurring at processor 102 or processor 104, supply electrical power to processor 102 and/or processor 104 to compensate for primary power supply 106 being unable to supply the required amount of electrical power to processor 102 and/or processor 104 when the transient occurs. When the supplemental power supplied by the supplemental power supply system 110 is no longer needed, supplemental power supply system 110 may cease supplying electrical power to processor 102 and/or processor 104. The supplemental power may no longer be needed when, for example, the transient condition ends (e.g., when processor 102 and/or processor 104 ceases drawing the increased level of current). As another example, the supplemental power may no longer be needed when primary power supply 106 is able to increase the amount of electrical power supplied to processor 102 and/or processor 104 to compensate for the increased power draw of the transient condition, ensuring that the voltage supplied by primary power supply 106 to processor 102 and/or processor 104 remains at pre-transient levels.

In the example of FIG. 1, supplemental power supply system 110 may be operably coupled to primary power supply 106 and processors 102 and 104, and may include controller 112, charging circuitry 114, discharging circuitry 116, and energy storage 118. Energy storage 118 may be any suitable device or devices for storing electrical energy, including but not limited to one or more of batteries, capacitors, supercapacitors, and the like. When energy storage 118 includes multiple different types of energy storage devices, energy storage 118 may perform any suitable filtering or any suitable inductances to use the different types of energy storage devices in parallel.

Charging circuitry 114 may be any suitable device, devices, or logical circuitry operable to charge energy storage 118 using electrical power supplied by primary power supply 106 and to maintain a sufficient charge at energy storage 118. Charging circuitry 114 may be operably coupled to primary power supply 106 to receive electrical energy, and may be operably coupled to energy storage 118 to transmit the electrical energy received from primary power supply 106 to energy storage 118 to maintain charge at energy storage 118. One example of charging circuitry 114 may be a boost converter that steps up voltage received from primary power supply 106 to energy storage 118.

Discharging circuitry 116 may be any suitable device, devices, or logical circuitry for discharging energy storage 118 and using the discharged energy to supply electrical power to processor 102 and/or processor 104 in response to transients occurring at processor 102 and/or processor 104. Discharging circuitry 116 may be operably coupled to energy storage 118 to receive electrical energy from energy storage 118, and may be operably coupled to processors 102 and processors 104 to supply electrical energy to processor 102 and/or processor 104. One example of discharging circuitry 116 may be a buck converter that steps down voltage received from energy storage 118 to processor 102 and/or processor 104.

Controller 112 may be any suitable device or devices for controlling the operations of charging circuitry 114, discharging circuitry 116, and energy storage 118. In particular, controller 112 may control the charging and discharging of energy storage 118 by charging circuitry 114 and discharging circuitry 116, respectively. Controller 112 may control the operations of charging circuitry 114, discharging circuitry 116, and energy storage 118 based at least in part on determining that occurred transient has started to occur or is about to occur at processor 102 or processor 104. Examples of controller 112 may include one or more microcontrollers, programmable logic devices, or any other suitable logic circuitry.

Controller 112 may determine whether a transient has started to occur at a processor (e.g., one of processors 102 and 104) based at least in part on detecting a drop in voltage of the electrical power that is being supplied to the processor. For example, controller 112 may determine that a transient has started to occur at processor 102 in response to detecting a voltage drop at the voltage of the electrical power being supplied by primary power supply 106 to processor 102. Similarly, controller 112 may determine that a transient has started to occur at processor 104 in response to detecting a voltage drop at the voltage of the electrical power being supplied by primary power supply 106 to processor 104.

Controller 112 may also determine whether a transient is occurring by communicating with processors 102 and 104 and receiving from processors 102 and/or 104 that a transient is occurring or is about to occur. Because a transient at a processor can be caused by the processor increasing its clock rate, and because a processor controls its clock rate, a processor can send an indication to controller 112 that it is about to increase its clock rate to indicate to controller 112 that a transient is about to occur at the processor. Similarly, a processor can send an indication to controller 112 that it has increased its clock rate to indicate to controller 112 that a transient is occurring at the processor. In this way, controller may receive an indication from processor 102 or 104 that a transient is about to occur or is occurring at processor 102 or 104.

Controller 112 may also determine whether a transient is occurring by communicating with primary power supply 106. Primary power supply 106 may be overloaded during a processor transient. If primary power supply 106 experiences an overload condition, primary power supply 106 may communicate with controller 112 to indicate that a processor transient is occurring.

Controller 112 may also determine whether a transient is occurring by snooping the communication bus between a processor (e.g., one of processors 102 and 104) and a voltage regulator for the processor. A voltage regulator may be a device between primary power supply 106 and a processor that provides the processor with the appropriate supply voltage by converting the voltage of the electrical power supplied by primary power supply 106 to a lower voltage required by the processor. The processor may communicate with a voltage regulator to direct the voltage regulator increase its voltage level prior to a large transient to accommodate the voltage losses that occur with increases in current. Controller 112 may observe this or a similar transaction on the communication bus between the processor and the voltage regulator to determine that a transient is about to occur at the processor.

Controller 112 may also monitor the current going into a processor (e.g., one of processors 102 and 104), such as via use of one or more sensors. When controller 112 observes an increase in the amount of current drawn by a processor, controller 112 may determine that a transient is occurring at the processor. In this manner, controller 112 may directly measure and observe the current transient.

Controller 112 may also determine when the transient condition has ended. For example, controller 112 may receive from a processor (e.g., one of processor 102 or processor 104) experiencing the transient condition that it has decreases the clock rate at which it operates back to the base operating frequency. Similarly controller 112 may determine that primary power supply 106 is able to supply sufficient electrical power to processor 102 and/or processor 104 such that supplemental power supply system no longer needs to supply electrical power to processor 102 and processor 104. For example, controller 112 may determine that the level of voltage of the electrical power supplied by primary power supply 106 has increased to a level that is sufficient for the operations of processor 102 and processor 104, such as by determining that the level of voltage of the electrical power supplied by primary power supply 106 has recovered to a pre-transient level of voltage. In another example, controller 112 may communicate with primary power supply 106 to receive an indication from primary power supply 106 that it is supplying sufficient electrical power to processor 102 and processor 104.

Controller 112 may operate to control charging circuitry 114 to charge energy storage 118 with electrical energy and to control discharging circuitry 116 to discharge electrical power from energy storage 118 in order to supply processor 102 and/or processor 104 with electrical power in response to determining that a transient has occurred at processor 102 and/or processor 104. Controller 112 may operate to control charging circuitry 114 and discharging circuitry 116 so that charging circuitry 114 and discharging circuitry 116 do not operate simultaneously. In other words, controller 112 may control charging circuitry 114 and discharging circuitry 116 so that only one of charging circuitry 114 or discharging circuitry 116 operates at a time. Therefore, when charging circuitry 114 is charging energy storage 118, controller 112 controls discharging circuitry 116 so that discharging circuitry 116 is not also discharging energy storage 118 at the same time. Similarly, when discharger is discharging energy storage 118, controller 112 controls charging circuitry 114 so that charging circuitry 114 is not also charging energy storage 118 at the same time.

System manager 120 may be any device or logic circuitry that may operate to provide system information to controller 112 that controller 112 may use to control charging circuitry 114's charging of energy storage 118 and to control discharging circuitry 116's discharging of energy storage 118. System information provided by system manager 120 may include information regarding the electrical power and voltage requirements of processors 102 and 104 so that controller 112 may control the amount of electrical power that is supplied by discharging circuitry 116 to a processor in response to the occurrence of a transient at the processor. For example, if system manager 120 provides the voltage requirement of processor 102 to controller 112, and if controller 112 determines the level of voltage of the electrical power supplied to processor 102 when a transient occurs at processor 102, controller 112 may direct discharge circuitry 116 to discharge energy storage 118 to supply electrical power having a level of voltage to processor 102 that is the difference between the voltage requirement of processor 102 and the level of voltage supplied by primary power supply 106 to processor 102 when the transient occurs at processor 102.

System information provided by system manager 120 may also include information that controller 112 may use to determine the charge voltage at which charging circuitry 114 charges energy storage 118 and to determine the recharge time for charging energy storage 118. System manager 120 may send to controller 112 indications of how often a transient may reoccur at processors 102 and/or 104. This information allows controller 112 to determine the amount of charging time is available before another transient may occur at processors 102 and/or 104. The longer the charging time that is available for charging circuitry 114 to charge energy storage 118, the lesser the impact to the loading on the primary power supply, such as primary power supply 106 from charging energy storage 118 because charging circuitry 114 may draw relatively less electrical power from primary power supply 106 to charge energy storage 118.

Controller 112 may control the operations of charging circuitry 114 and discharging circuitry 116 based at least in part on whether it determines that a transient is occurring at one of processor 102 or processor 104. When controller 112 has not detected that a transient is occurring or is about to occur at one of processors 102 or processor 104, controller 112 may direct charging circuitry 114 to charge energy storage 118 with electrical power from primary power supply 106 until energy storage 118 is fully charged or until controller 112 determines that a transient is occurring or is about to occur at one of processors 102 or processor 104.

When controller 112 determines that a transient is occurring or is about to occur at one of processor 102 or processor 104, controller 112 may determine whether charging circuitry 114 is charging energy storage 118 and, if so, may direct charging circuitry 114 to stop charging energy storage 118, and may direct discharging circuitry 116 to start discharging energy storage 118 and to supply electrical power to the processor at which the transient has occurred. As discussed above, controller 112 may use system information received from system manager 120 to determine the amount of electrical power that is supplied by discharging circuitry 116 to compensate for the increased amount of electrical power required by the processor at which the transient is occurring that primary power supply 106 is unable to supply. In addition, controller 112 may direct discharging circuitry 116 to supply electrical power to not only the processor at which the transient has occurred but also to additional components of computing device 100. For example, if controller 112 determines that a transient has occurred at processor 102, controller 112 may direct discharging circuitry 116 to supply electrical power to processor 104 in addition to processor 102.

Controller 112 may direct discharging circuitry 116 to supply electrical power until it determines that the transient condition has ended or until it determines that primary power supply 106 has increased its supply of electrical power to supply a sufficient level of electrical power for the transient condition. In response to determining that the transient condition has ended or in response to determining that primary power supply 106 is able to increase its supply of electrical power to supply a sufficient level of electrical power for the transient condition, controller 112 may direct discharging circuitry 116 to stop discharging electrical energy from energy storage 118 and to stop supplying electrical power. Controller 112 may, in response to determining that discharging circuitry 116 has stopped discharging electrical energy from energy storage 118, direct charging circuitry 114 to charge energy storage 118. Controller 112 may continuously determine whether a transient condition is occurring or is about to occur at processor 102 and/or processor 104 and to control charging circuitry 114 and discharging circuitry 114 based on whether it determines whether a transient condition has occurred or is about to occur at processor 102 and/or processor 104.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

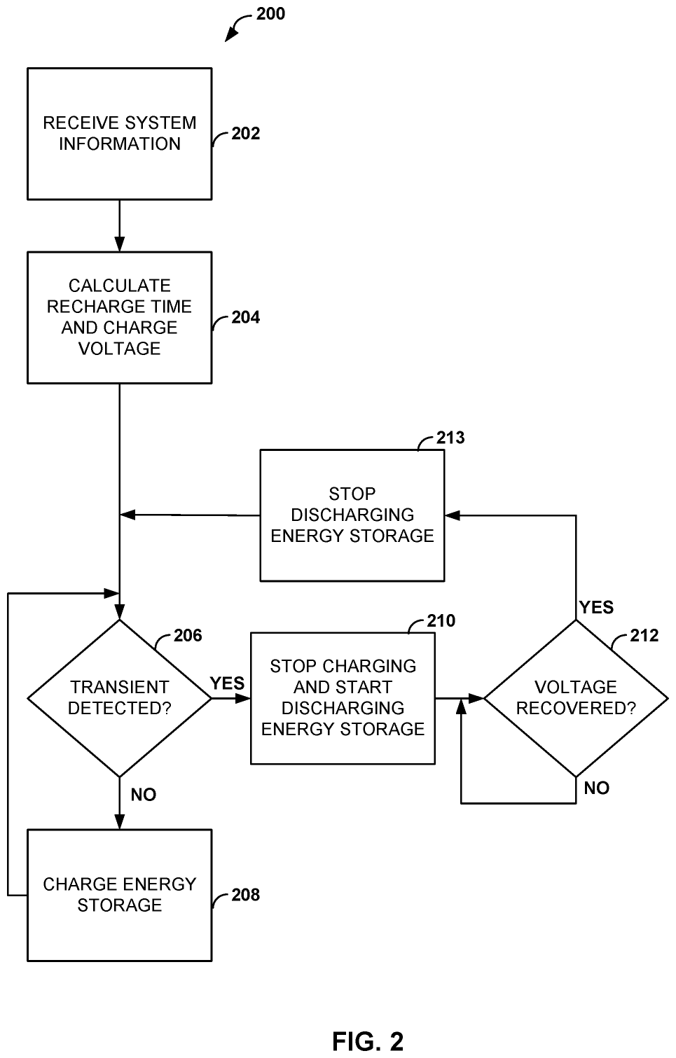

FIG. 2 illustrates an example process 200 for supplementing the electrical power supplied by an example primary power supply 106 when a transient occurs at an example processor 102. While FIG. 2 is described with reference to FIG. 1, it should be noted that the process steps of FIG. 2 may be performed by other systems.

Process 200 includes controller 112 receiving system information from one or more of system manager 120, processor 102, processor 104, or primary power supply 106 (202). The system information received by controller 112 may include information related to transients that may occur and processor 102 and/or processor 104, such as transient frequency, transient duration, maximum charge current, transient current step, transient system load, maximum loading of primary power supply 116, and the like.

Process 200 further includes controller 112 calculating recharge time and charge voltage for energy storage 118 based at least in part on the system information received by controller 112 (204). For example, if the system information received by controller 112 indicates a transient frequency of 5 hertz and a transient duration of 1 millisecond (ms), then computing device 100 that includes two processors 102 and 104 may at most experience 10 ms of transient per second. Thus, controller 112 may determine that charging circuitry 114 may charge energy storage 118 for 990 ms each second, and may determine the recharge time for energy storage 118 and the rate at which charging circuitry 114 charges energy storage 118 based on the system information.

Controller 112 may also determine the charge voltage for energy storage 118 based on the total energy required during the transient, which is the transient system load less the maximum loading of primary power supply 106. Controller 112 may calculate the corresponding charge voltage level for energy storage 118 in order to provide the ability to meet the total energy required during the transient. For example, the total energy required during a transient, for capacitors, may equal one half times the capacitance of the capacitance of the capacitors times the square of the charge voltage level (i.e., E=0.5*C*V²). Energy storage 118 may have a charge voltage level having a corresponding total charged energy and a stop discharge voltage level or minimum voltage at which energy storage 118 may operate. The difference in the energy stored in energy storage 118 between the charge voltage level and the stop discharge voltage level may be the energy required during a transient as calculated above.

Process 200 further includes controller 112 determining whether a transient is occurring or will occur at processor 102 or processor 104 (206). Controller 112 may make such a determination via various ways. For example, controller 112 may determine whether there has been a voltage drop in the voltage of the electrical power being supplied by primary power supply 106 to processor 102 in the case of determining whether a transient is occurring at processor 102, or determine whether there has been a voltage drop in the voltage of the electrical power being supplied by primary power supply 106 to processor 104 in the case of determining whether a transient is occurring at processor 104. Alternatively, controller 112 may snoop the communication bus between processor 102 and a voltage regulator for processor 102, or the communication bus between processor 104 and a voltage regulator for processor 104. In another example, controller 112 may receive from processor 102 an indication that a transient is occurring or is about to occur from processor 102, or receive from processor 104 an indication that a transient is occurring or is about to occur from processor 104.

When controller 112 has determined that a transient has not occurred at processor 102 or processor 104, controller 112 may communicate with charging circuitry 114 to direct charging circuitry 114 to charge energy storage 118 with electrical energy supplied by primary power supply 106 (208). Controller may direct charging circuitry 114 to operate according to the recharge time and charge voltage for energy storage 118 determined in step 204, so that charging circuitry 114 charges energy storage 118 with the charge voltage and for the recharge time as determined by controller 112.

As charging circuitry 114 charges energy storage 118, controller 112 may continue to determine whether a transient has occurred at processor 102 or processor 104, according to step 206. In response to determining that a transient has occurred at processor 102 or processor 104, controller 112 may direct charging circuitry 114 to stop charging energy storage 118 and may direct discharging circuitry 116 to start discharging energy storage 118 to supply electrical power to processor 102 and/or processor 104 to compensate for primary power supply 106 being unable to supply the additional electrical power required by processor 102 and/or processor 104 during the occurrence of the transient (210). Because the transient may cause the voltage supplied by power supply 106 to drop for not only the voltage supplied to the processor at which the transient occurred, controller 112 may direct discharging circuitry 116 to supply electrical power to both processors 102 and 104 in response to determining that a transient has occurred, regardless of whether the transient has occurred at one or both of processors 102 and 104.

As discharging circuitry 116 supplies electrical energy to processors 102 and 104, controller 112 may determine whether the voltage supplied by power supply 106 to processors 102 and 104 has recovered to a level where it is no longer necessary for discharging circuitry 116 to supply electrical power to processors 102 and 104 (212). For example, if the transient has ended, such as when the processor that causes the transient by increasing its operating clock rate decreases its operating clock rate, primary power supply 106 may once again be able to meet the electrical power requirements of the processor. In another example, if primary power supply 106 is not able to immediately ramp up its power supply to processors 102 and 104 in response to the occurrence of a transient, discharging circuitry 116 may be able to supply electrical power to processors 102 and 104 at least until primary power supply 106 ramps up its electrical supply to processors 102 and 104.

Controller 112 may determine, either directly or indirectly, whether the supplemental power supplied by the discharging circuitry 116 is still needed. For example, the controller 112 may determine that the supplemental power is no longer needed when a transient has ended. The controller 112 may determine that a transient has ended by using any of the same techniques described above for determining that the transient was occurring. As another example, the controller 112 may determine that the supplemental power is no longer needed when the electrical power supplied by primary power supply 106 to processors 102 and 104 is at an acceptable level. For example, controller 112 may be able to directly determine whether the electrical power supplied by primary power supply 106 is at a level where it is no longer necessary for discharging circuitry 116 to supply electrical power to processors 102 and 104 by measuring the voltage level of the electrical power being supplied by primary power supply 106 to determine whether the voltage level of the electrical power has recovered to a pre-transient level. Alternatively, primary power supply 106 may communicate with controller 112 to indicate to controller 112 that the voltage level of the electric power it supplies to processor 102 and 104 has recovered to a pre-transient level. In another example, processors 102 and/or 104 may communicate with controller 112 to indicate that primary power supply 106 is meeting the electrical power requirements of processors 102 and/or 104.

When controller 112 determines that it is no longer necessary for discharging circuitry 116 to supply supplemental power to processors 102 and 104, controller 112 may direct discharging circuitry 116 to stop supplying electrical power to processors 102 and 104, and to stop discharging electrical storage 118. The process may return to step 206 where controller 112 may monitor computing device 100 to determine whether a transient has occurred at processor 102 or processor 104.

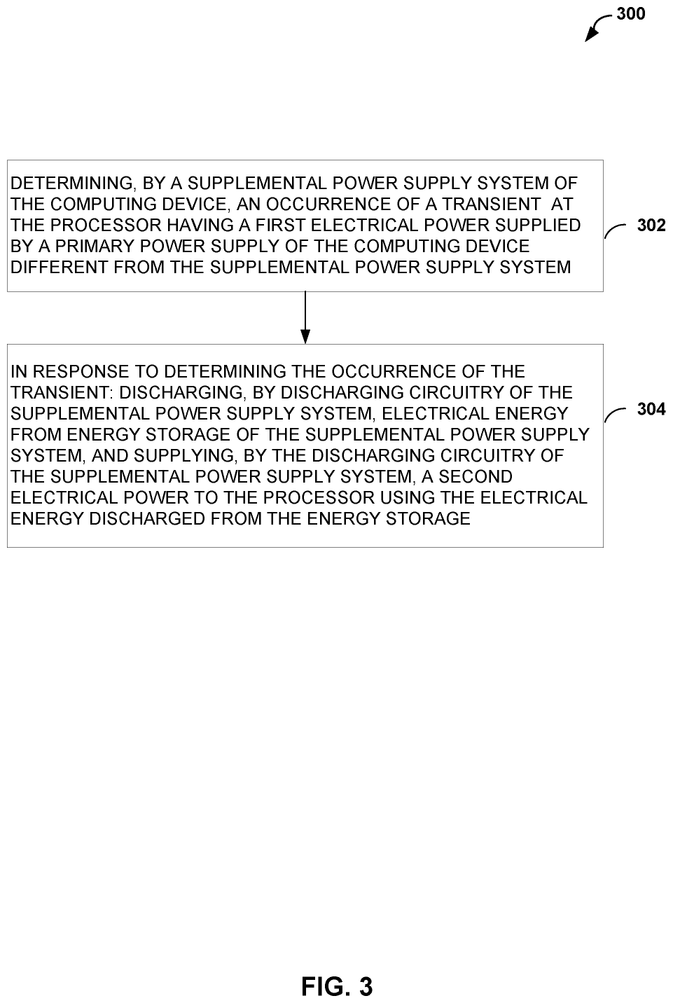

FIG. 3 illustrates an example process 300 for supplementing the electrical power supplied by an example primary power supply 106 when a transient occurs at an example processor 102. While FIG. 3 is described with reference to FIG. 1, it should be noted that the process steps of FIG. 3 may be performed by other systems.

Process 300 includes a supplemental power supply system 110 of a computing device 100 determining an occurrence of a transient at a processor (e.g., one of processor 102 or processor 104) of the computing device 100 having a first electrical power supplied by a primary power supply 106 of the computing device 100 different from the supplemental power supply system 110 (302). Process 300 further includes a discharging circuitry 116 of the supplemental power supply system 110, in response to determining the occurrence of the transient, discharging electrical energy from energy storage 118 of the supplemental power supply system 110 and supplying a second electrical power to the processor (e.g., processor 102 and/or processor 104) using the electrical energy discharged from the energy storage 118 (304).

In some examples, the supplemental power supply system 110 determining the occurrence of the transient at the processor of the computing device 100 may further include the supplemental power supply system 110 determining a voltage drop in the first electrical power supplied by the primary power supply 106. In some examples, the supplemental power supply system 110 determining the occurrence of the transient at the processor of the computing device 100 may further include the supplemental power supply system 110 receiving, from the processor at which the transient is occurring (e.g., one of processor 102 or processor 104), an indication that the transient is occurring at the processor.

In some examples, the supplemental power supply system 110 supplying the second electrical power to the processor of the computing device 110 may further include the supplemental power supply system 110 supplying the second electrical power at least until the voltage ends.

In some examples, process 300 may further include charging circuitry 114 of the supplemental power supply system 110 charging the energy storage 118 of the supplemental power supply system 110 and, in response to determining the occurrence of the transient, stopping the charging of the energy storage 118 of the supplemental power supply system 110.

In some examples, the charging circuitry 114, in response to supplemental power supply system 110 determining that the discharging circuitry 116 of the supplemental power supply system 110 has stopped discharging the energy storage 118, resuming charging of the energy storage 118 of the supplemental power supply system 110.

In some examples, process 300 may further include controller circuitry 112 of the supplemental power supply system 110 controlling the charging of the energy storage 118 by the charging circuitry 114 and the discharging of the energy storage 118 by the discharging circuitry 116.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “example” or “exemplary” is used herein to mean “serving as an example, instance, or illustration.” Any embodiment described herein as “example” or “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for supplying supplemental electrical power to a processor of a computing device, the method comprising:
determining, by a supplemental power supply system of the computing device, an occurrence of a transient at the processor having a first electrical power supplied by a primary power supply of the computing device different from the supplemental power supply system; and
in response to determining the occurrence of the transient:
discharging, by discharging circuitry of the supplemental power supply system, electrical energy from energy storage of the supplemental power supply system, and
supplying, by the discharging circuitry of the supplemental power supply system, a second electrical power to the processor using the electrical energy discharged from the energy storage.

2. The computer-implemented method of claim 1, wherein determining the occurrence of the transient at the processor of the computing device further comprises:
determining, by the supplemental power supply system, a voltage drop in the first electrical power supplied by the primary power supply.

3. The computer-implemented method of claim 1, wherein determining the occurrence of the transient at the processor of the computing device further comprises:
receiving, by the supplemental power supply system from the processor, an indication that the transient is occurring at the processor.

4. The computer-implemented method of claim 1, wherein supplying the second electrical power to the processor of the computing device further comprises:
supplying, by the supplemental power supply system, the second electrical power at least until the transient ends.

5. The computer-implemented method of claim 1, further comprising:
charging, by charging circuitry of the supplemental power supply system, the energy storage of the supplemental power supply system; and
in response to determining the occurrence of the transient, stopping the charging of the energy storage of the supplemental power supply system.

6. The computer-implemented method of claim 5, further comprising:
in response to determining that the discharging circuitry of the supplemental power supply system has stopped discharging the energy storage of the supplemental power supply system, resuming the charging, by the charging circuitry of the supplemental power supply system, of the energy storage of the supplemental power supply system.

7. The computer-implemented method of claim 6, further comprising:
controlling, by a controller circuitry of the supplemental power supply system, the charging of the energy storage by the charging circuitry and the discharging of the energy storage by the discharging circuitry.

8. A computing device comprising:
a processor;
a primary power supply configured to supply a first electrical power to the processor during operations of the processor; and
a supplemental power supply system including energy storage and discharging circuitry, the supplemental power supply configured to determine an occurrence of a transient at the processor;
wherein the discharging circuitry is configured, in response to determining the occurrence of the transient, to:
discharge electrical energy from the energy storage, and
supply a second electrical power to the processor using the electrical energy discharged from the energy storage

9. The computing device of claim 8, wherein the supplemental power supply system that is configured to determine the occurrence of the transient at the processor is further configured to determine a voltage drop in the first electrical power supplied by the primary power supply.

10. The computing device of claim 8, wherein the supplemental power supply system that is configured to determine the occurrence of the transient at the processor is further configured to receive, from the processor, an indication that the transient is occurring at the processor.

11. The computing device of claim 8, wherein the discharging circuitry that is configured to supply the second electrical power to the processor is further configured to supply the second electrical power at least until the transient ends.

12. The computing device of claim 8, wherein the supplemental power supply system further includes:
charging circuitry configured to:
charge the energy storage; and
in response to the supplemental power supply system determining the occurrence of the transient, stop charging the energy storage.

13. The computing device of claim 12, wherein the charging circuitry is further configured to:
in response to determining that the discharging circuitry of the supplemental power supply system has stopped discharging the energy storage of the supplemental power supply system, resume the charging of the energy storage.

14. The computing device of claim 13, wherein the supplemental power supply system further includes a controller circuitry configured to control the charging of the energy storage by the charging circuitry and the discharging of the energy storage by the discharging circuitry.

15. A supplemental power supply system comprising:
energy storage configured to store electrical energy;
a controller configured to determine an occurrence of a transient at a processor having a first electrical power supplied by a primary power supply;
charging circuitry configured to charge the energy storage; and
discharging circuitry configured, in response to the controller determining the occurrence of the transient, to:
discharge electrical energy from the energy storage; and
supply, using the electrical energy discharged from the energy storage, a second electrical power to the processor.

16. The supplemental power supply system of claim 15, wherein the controller that is configured to determine the occurrence of the transient at the processor is further configured to determine a voltage drop in the first electrical power supplied by the primary power supply.

17. The supplemental power supply system of claim 15, wherein the controller that is configured to determine the occurrence of the transient at the processor is further configured to receive, from the processor, an indication that the transient is occurring at the processor.

18. The supplemental power supply system of claim 15, wherein the discharging circuitry is further configured to supply the second electrical power at least until the transient ends.

19. The supplemental power supply system of claim 15, wherein the charging circuitry is further configured, in response to the controller determining the occurrence of the transient, to stop charging the energy storage.

20. The supplemental power supply system of claim 15, wherein the charging circuitry is further configured, in response to the controller determining that the discharging circuitry of the supplemental power supply system has stopped discharging the energy storage, to resume the charging of the energy storage.
